(19) United States
(12) Patent Application Publication
(10) Pub. No.: US 2016/0132830 A1
(43) Pub. Date: May 12, 2016

(54) MULTI-LEVEL SCORE BASED TITLE ENGINE

(71) Applicant: ADP, LLC, Roseland, NJ (US)

(72) Inventors: Rong Zhang, Warren, NJ (US); Rui Yang, Edison, NJ (US); Xiaojing Wang, Warren, NJ (US)

(21) Appl. No.: 14/538,904

(22) Filed: Nov. 12, 2014

(51) Int. Cl. G06Q 10/10; G06F 17/30

(52) U.S. Cl. CPC G06Q 10/105; G06F 17/30345

(57) ABSTRACT

In response to a data input of a title text string that indicates a title of a person for a job within an organization, title scores are generated for predefined titles in proportion to strength of match to the title text string. A predefined title having the highest title score is selected as a matching title for the title text string input. A person score is generated from the title score of the matching title as a function of other title scores of the predefined titles matched to the person. An organization score is generated as a function of the person score and an occurrence frequency of the matching title associated with the organization. Classification of the matching title within a classification database is updated as a function of one or more of the organization score, the title score and the person score.

### BACKGROUND

Human resource management (sometimes “HRM” or “HR”) generally refers to functions and systems deployed in organizations that are designed to facilitate or improve employee, member or participant performance in service of an organization or employer's strategic objectives. HR comprehends how people are identified, categorized and managed within organizations via a variety of policies and systems. Human Resources management systems may span different organization departments and units with distinguished activity responsibilities: examples include employee retention, recruitment, training and development, performance appraisal, managing pay and benefits, and observing and defining regulations arising from collective bargaining and governmental laws. Human Resources Information Systems (HRIS) comprehend information technology (IT) systems and processes configured and deployed in the service of HR, and HR data processing systems integrate and manage information from a variety of different applications and databases.

### BRIEF SUMMARY

In one aspect of the present invention, a method for score-based title assignment includes generating title scores in proportion to strength of match to a title text string input for each of a plurality of predefined titles that are classified within a classification database, in response to a data input of the title text string that also indicates a title of a person for a job within an organization. The predefined title having the highest title score is selected as a matching title for the title text string input. A person score is generated for the person from the title score of the matching title as a function of any other title score of any other of the predefined titles that are matched to the person. An organization score is generated as a function of the person score and an occurrence frequency of the matching title associated with the organization. A classification of the matching title within the classification database is updated as a function of one or more of the organization score, the title score and the person score.

In another aspect, a system has a processor in circuit communication with a computer-readable memory and a computer-readable storage medium having program instructions. The processor executes the program instructions stored on the computer-readable storage medium via the computer-readable memory and thereby generates title scores in proportion to strength of match to a title text string input for each of a plurality of predefined titles that are classified within a classification database, in response to a data input of the title text string that also indicates a title of a person for a job within an organization. The predefined title having the highest title score is selected as a matching title for the title text string input. A person score is generated for the person from the title score of the matching title as a function of any other title score of any other of the predefined titles that are matched to the person. An organization score is generated as a function of the person score and an occurrence frequency of the matching title associated with the organization. A classification of the matching title within the classification database is updated as a function of one or more of the organization score, the title score and the person score.

In another aspect, a computer program product has a computer-readable storage medium with computer-readable program code embodied therewith. The computer-readable program code includes instructions for execution by a processor that cause the processor to generate title scores in proportion to strength of match to a title text string input for each of a plurality of predefined titles that are classified within a classification database, in response to a data input of the title text string that also indicates a title of a person for a job within an organization. The predefined title having the highest title score is selected as a matching title for the title text string input. A person score is generated for the person from the title score of the matching title as a function of any other title score of any other of the predefined titles that are matched to the person. An organization score is generated as a function of the person score and an occurrence frequency of the matching title associated with the organization. A classification of the matching title within the classification database is updated as a function of one or more of the organization score, the title score and the person score.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method or process aspect according to the present invention for score-based title assignment.

FIG. 2 depicts a score-based title engine according to an aspect of the present invention.

FIG. 3 depicts a computer device according to the present invention.

### DETAILED DESCRIPTION

HR functions include recognizing and processing a wide variety of employee data including personal histories, skills, capabilities, accomplishments and salary. In establishing salary and other compensation values, organizations deploy a variety of formalized selection, evaluation, and payroll processes that consider employee or member title classifications as distinguishing characteristics in the processing of such data. For example, compensation and benefits award to an employee may be dependent on a designated job title for that employee within the organization. Comparing compensation and benefits offered to different employees both within and outside an organization is necessary to recognize if one employee is underpaid or overpaid relative to another employee, or to determine an appropriate financial incentive offer to induce an employee to remain with or join an organization. Comparisons with other employees are often dependent on accurately determining their respective titles.

However, different organizations, or different units within the same organization, often use different terms or title nomenclature to refer to similar occupations. They may also use single job titles to pack in, signify or represent a wide variety of different tasks and information. For example, one single short, ambiguous text field “title” identifier entry may be used to signify a job title, job function, management level and other occupational and organizational information data that may vary among employees, which may hold the same or similar titles. This may result in title data entries within HR information system data fields taking on a semi-structured, semi-encrypted data language or format characteristic that is opaque to automated analytic processing. Accordingly, it may not be possible for a single automated application or data format to reliably decipher the import and meaning of the data underlying or represented by a title entry.

FIG. 1 illustrates a method for score-based title assignment according to the present invention. The method addresses the absence of standardized generic job classification systems applicable across different organizations, or units within an organization, by reliably classifying job titles and underlying employee HR data across pluralities of different organization structure, formats and nomenclatures.

Thus, a data input at 82 includes a title text string that indicates a title of a person for a job within an organization (business, company, governmental entity, etc.). The text string terms may include an acronym or industry-specific terminology term, and the input may be received as a title input within a data entry field with respect to employee data for the employee, though other text terms and input processes may be practiced.

In response to said input, at 84 an automated title engine device (for example, a hardware processor of a client-server computer that is executing programming code, or other automated human resource management system hardware processor component) generates title scores in proportion to strength of match to the title text string input for each of a plurality of different predefined titles that are classified within a title dictionary or other classification database. At 86 the automated title engine device selects the predefined title having a highest of the generated title scores as a matching title for the title text string input.

At 88 a person score is generated for the person (as identified by the data input at 82) from the title score of the matching title as a function of any other title score of any other of the predefined titles that are matched to the person. In some examples, the person scores values are proportionate to a total number of the predefined titles that have title scores, and in some aspects as limited to titles that have values meeting a minimum “verified title” score threshold. The person score reflects how many competing or alternative titles are recognized or associated with the person as indicated by title text input terms 82, or by other data inputs or person history data, or that are otherwise matched to titles defined within the title dictionary or other classification database.

The person score may also be generated at 88 as a function of other data extracted relative to identification of the person and the organization in the input at 82. Thus, employee department title or function data (for example, “research and development”), management category data (for example, a flag indicating manager or non-manager), industry type data (for example, “Information,” Legal Support Services,” etc.), and work day or shift data (for example, “full-time, days, “part-time, third shift,” “seasonal-(part or full) time,” etc.) may also serve as input data, to generate or weight the person score.

Generating title scores at 84 or the person score at 88 may be limited to matching only those titles available within the organization of the data input at 82, as well as expanding the scope of either to reflect matches to other titles outside of said organization. Thus, in one example, if three different generated title scores are generated for matching the title string input(s) at 82 (optionally wherein each meet a minimum matching threshold), then the person score may be the average of the three title scores, or each title score may be given a one-third (33.3%) confidence rating person score. If no other titles match or result in a title score (verified or not) at 84, then the title score and the person score may be equivalent, or the person score may have a 100% weighting.

At 90 an organization score is generated as a function of the person score and an occurrence frequency of the matching title associated with the organization. The organization score may reflect the weight or usage of the matching title relative to the titles of other employees within the organization as reflected within a classification database that is relevant to or associated with the organization. Alternatively, the frequency may be determined from structures and hierarchies of other organizations, or of composite data considering the organization with other organizations of similar type or within common categories. In some examples, generating the organization score for a possible matching title defined in the term dictionary includes setting the value in proportion to a correlation of an employee position to a position of said possible matching title within the occupation classifier hierarchy data.

At 92 a classification of the matching title within the classification database is updated as a function of at least one of the organization score, the title score and the person score. In some examples, updating the classification at 92 includes linking the matching title to the title text string input with a confidence value determined as a function of the title score and the organization score and/or the person score.

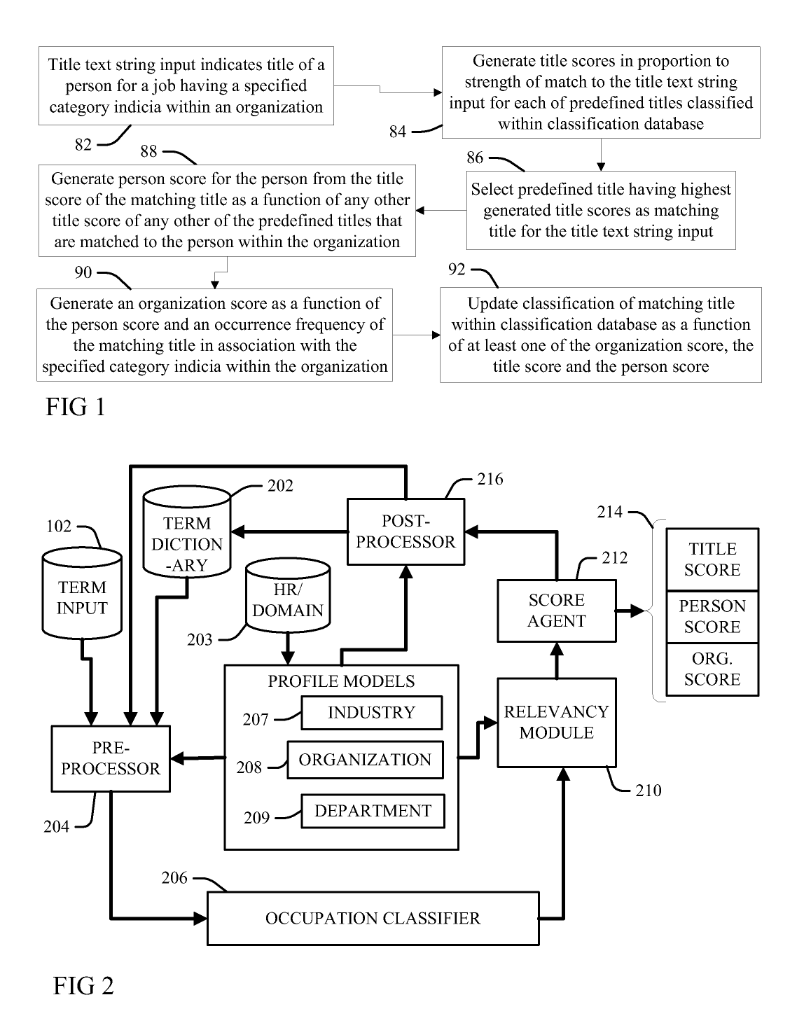

FIG. 2 illustrates a score-based title engine according to the present invention that implements the process or system of FIG. 1 discussed above. Aspects of the score-based title engine of the present invention provide client-server, application service provider, and software as a service (SaaS) of human resource management systems that enable automated and timely administrative control of the processing of employee data.

A pre-processor 204 is a pre-processing sub-system associated with an occupation classifier 206 that processes the text string terms of the data input 102 as a function of a terminology dictionary 202, a classification database of the occupation classifier 206 and a plurality of profile models that includes an industry profile model 207, an organization profile model 208 and a department profile model 209. Prior art title term input analysis typically uses only natural language processes to find matches to extant titles, which is not useful with respect to abstract industry acronyms that are only indirectly representative of underlying word term information. A wide variety of organizational information may be represented by a single, cryptic text term title entry, and aspects of the present invention use employee and organizational classifications and associated non-text input data found in or defined by the terminology dictionary 202, industry profile model 207, organization profile model 208, department profile model 209 and classification database of the occupation classifier 206 to provide contextual data to unpack this information. Whereas prior art natural language searching may ignore some elements as noise, the present embodiments consider such otherwise ignored elements to determine which and what title data is represented by individual elements of the string text entries.

Aspects of the pre-processor 204 utilize Natural Language Processing (NLP) techniques to clean and re-structure the input data into terms defined within the terminology (term) dictionary 202 that are relevant to predefined titles found in the classification database of the occupation classifier 206, in some aspects as a function of the feature data extracted from text string terms and/or category indicia of the data input. The title score may indicate how close, on an objective scored basis, the text string terms are to the title terms defined in the title term dictionary resource 202 and/or occupation classifier 206 classification database, based on one or more of machine translation, machine learning, natural language processing, semantic search application outputs, etc.

The pre-processor 204 may consider feature signals extracted from dimensions of the data input that provide understanding and context in translating or normalizing the input title text term into a recognized job title that has objective or semantic meaning or value in view of the classification database of the occupation classifier 206. The pre-processor 204 may function as a string level extractor that analyzes string data of the input title text term and looks for matches to terms in the title term dictionary relevant to titles known and stored in the occupation classifier 206. For example, an input text string term of “Tm_Ldr” may match the term “team leader” stored within the title term dictionary with a 90% probability, as a function of determining that they have all consonants in common and differ only by omitting vowels, a common abbreviation technique. In other examples, a consonant-only rule may determine that this is a 100% amount of match.

Feature extraction may provide non-text-based analysis signals for use by the pre-processor 204. Data including organization structure, age of employee, number of years in current position, known skill set, where they work, commute distance, what does this person do, how long has the employee stayed with this job, why did he leave the last job, etc., may also provide feature signals relative to term and title matching and selection. For example, the occupation classifier 206 may classify the position of a “team leader” within an organizational hierarchy. This data may indicate an expected associated position or salary scale for such an employee within the type of organization of the employee indicated by the employee or organization data, which may be checked against the salary and employee data of the organization to indicate a likelihood or strength of a positive signal for a match to the “team leader” title. Thus, an amount of correlation of salary data extracted for an employee associated with the title input term is calculated to expected salary indicated by the hierarchy data of an organization type that matches an organization type extracted from the feature data of the input title text term, and this correlation value is used to weight a generated title score.

Further, the process may determine whether counting the person as a “team leader” will result in an aggregate number of employees reported as “team leaders” for the organization that is within an expected range, and weight a matching “team leader” job title accordingly. The classification database within the occupation classifier may also indicate average (mean) employment period (number of years, months, or days, etc.) that “team leaders” remain with a given employer within similar organizations, wherein the pre-processor 204 generates a signal of relative likelihood that a matching title is correct for the person as a function of correlation of their present elapsed time of employment by the current organization with said average employment period.

Semantic extraction may include analyzing or parsing items that are expressed within the string text input terms as a function of a context of the organization data of the person. For example, if the employee organization data indicates employment by a financial services organization, a “bank interest” string input to a duties field associated with the “Tm_Ldr” input may be semantically understood as related to leadership of a team of bond traders (“team leader”) in view of known title classifications within financial services organizations reflected within the occupation classifier 206 data. In contrast, if the employee organization data indicates employment by a law firm, association of the “bank interest” string input with the “Tm_Ldr” input may be semantically understood as related to a “managing partner” title of a group of litigators, in view of known title classifications within law firms reflected within the occupation classifier data.

In one example, “banana developer” and “software engineer” title text items inputs apply to a same employee in multiple instances for a given organization that is identified as a software company by category indicia of the input at 82, by comparison to organizational hierarchical structures represented in the occupation classifier 206 classification data and correlating to the employee data. However, “banana developer” has no matches to known titles via the extracted feature title matching process with a threshold confidence value (for example, 50% or greater string matching confidence). This may indicate that “banana developer” refers to some type of in-house, proprietary or specialized software platform, which may result in a high confidence weighting (for example, 80%) indicating that the appropriate title match for “banana developer” for this employee is “software developer” within the context of the organization.

In another example, a pre-processor 204 compares an input text string term “prnpl hadoop sw” to the term dictionary 202, and finds an entry for “engineer—principle hadoop software.” The pre-processor 204 responsively transforms (or translates) the input string into a root job function component (“engineer”) that has a modifying subject matter scope dependency (“software”) which further encompasses a particular known software language (“Hadoop”): thus, “[root] engineer; [dependency]<Hadoop><software>.” This transformed data is then processed as a function of the industry profile model 207, organization profile model 208 and department profile model 209 in view of organizational information inputs from a Human Relations (HR) Domain database 203 to generate one or more relevancy and/or profile scores for use by a score agent 212 to generate the title, person and organization scores.

The pre-processor 204 uses the industry profile model 207 to determine a degree of correlation of matching titles, transformed components or other feature data extracted from the data input or organization to an industry of the organization. For example, comparing demographic data extracted for the person to relevant associated industry data including average wage, headcount, geographic locations, gender, etc., with stronger correlations generating a higher industry profile score component.

The pre-processor 204 uses the organization profile model 208 to determine a degree of correlation of matching titles, transformed components or other extracted feature data to intra-organization data. For example, comparing demographic data extracted for the person to organization structure, history, local eco system, financial environment and conditions, typical career paths, etc., of the organization, with stronger correlations generating a higher industry organization profile score component.

The pre-processor 204 uses the department profile model 209 to determine a degree of correlation of matching titles, transformed components or other extracted feature data to organization data. For example, comparing demographic data extracted for the person to department descriptions and structure within the profile of the organization, or to an organization profile applicable to the organization (based on industry, location, etc.), which may indicate additional features for job classification, and wherein stronger correlations generate a higher department profile score component.

A variety of processes may be practiced by the pre-processor 204 to transform string text and other extracted feature data into transformed components. Thus, a machine translation process may transform a “Softwaredevelper” string input into “software developer.” Pattern identification may transform “Ast To Vp Bus Dev & Vp Mktg” to “Assistant to VP business development & VP marketing.” The term “The director of software engineering” may be truncated or simplified into “Director, software engineering” by a stop-word process, which may be further transformed to a “Director/NNP-/: software/NN engineering/NN” expression by a relation identification process, or to a “[director] [,] [software] [engineering]” expression by a tokenization or punctuation process. Terms may also be simplified or reduced to common usages, for example transforming “productions” to “production” by a lemmatizer process, or to “product” by a stemmer process.

These transformed components may also be used to generate a plurality of differently weighted relevancy scores. For example, a first relevancy score may indicate how proximate the text string input or its transformed components are to a matching title, wherein a second (lesser weighted) relevancy score may indicate a degree of match of the text string input to a matching title, and a third (lowest weighted) relevancy score may indicate a strength of thematic match of underlying extracted person demographic data to the matched job title.

The occupation classifier 206 classification database includes standardized job classifications, job titles known and defined within human resources industry processes, as well as those defined by wiki and social sources, such as dynamic feeds from online job queries and associated job categories, brief job descriptions, etc. This data is used to drive a relevancy module 210 that generates title scores (at 84, FIG. 1) for matching titles, for example as a function of the industry profile score component, the organization profile score component, the department profile score component and the different relevancy scores. The relevancy module 210 defines a level of relevancy or similarity between the input text string terms and terms within the term dictionary 202 and job titles within the classification databases of the occupation classifier.

The occupation classifier 206 comprehends a tree structure or other relational classification database structure that defines relationships observed or determined between known job titles in occupation structure data provided or derived from surveys, data inputs from or studies of one or more different organizations. The more organizations used to generate classification data, the more robust the occupation classifier and the title relationships defined therein. Thus, the occupation classifier 206 classification data may indicate that a “team leader” title matched by a string level extractor to a “Tm_Ldr” title text term input 102 is known to be used within the type of organization indicated by employee or employee organization data, and generate a signal indicating the likelihood that this match is more true or false accordingly for use by the relevancy module 210.

The score agent 212 is a ranking system where, based on machine learning technology, the title, person and organization (“ORG.”) scores 214 are generated (at 84, 88 and 90, of FIG. 1, respectively), and best scored matching results are selected as mapped job titles (at 86). In some aspects, generating the person score recognizes that some titles are more important than others, or are complementary and not exclusionary with respect to each other, and weights them accordingly. Thus, person scores may be weighted as a function of their importance within the hierarchy data of a type of organization (as classified in the occupation classifier 206 classification data) that matches the extracted organization type, relative to other titles within the hierarchy data. In one example, an employee may also have an additional title input text string 82 (for example, “lf_sft_mrsh11”) which has a title score of 90% with respect to “life safety marshal,” but wherein the occupation classifier data indicates that this title represents safety responsibilities during fire drills or medical emergencies and is typically a voluntary and unpaid position that is unrelated to organizational titles that are descriptive of work duties and responsibilities. Accordingly, the “life safety marshal” title match may be disregarded (given no weight or a zero value) for consideration relative to the “team leader” title match, or to any other organizational titles and their relative scoring, resulting in a 0% title score for the “life safety marshal” match, and wherein the person scores for “team leader” and any other matched titles are not proportionately reduced by the presence of the “life safety marshal” title match. Thus, in the case of multiple titles, the organization data context may enable the scoring engine 212 to recognize that the differentiated titles are not important for this employee within relevant hierarchy structures defined within the occupation classifier data, for example, by reducing or eliminating the effect of the person scoring value in determining a title match.

The score agent 212 may further generate title scores for one occupation classifier title having value within an occupation classifier 206 classification (for example, “software developer”) for two or more other title text term string inputs (for example, “python developer” and “ninja developer”) that are not recognized within any of the applicable/relevant hierarchies. Further, the organization confidence score generated for said substitute title may be given a value or weighting corresponding to the likelihood that the substitute title is a good fit for the replaced titles. Organizational scoring aspects may also link “ninja developer” to “python developer” based on data derived from other organizations, or based on the organization score, hence for the data peculiar to this organization, so when the employee inputs “ninja developer” the system matches or assigns “python developer” as a matching title. Furthermore, if 80% of a group that the employee belongs to are python developers, and the majority of members of this group use ninja developer as their job title, aspects may determine that “ninja” and “python” terms are equivalent, for current title matching as well as term dictionary 202 and occupation classifier 206 database updates (as discussed below).

The score agent 212 may also recognize that an input field providing a text string input may only accommodate a maximum of two title inputs, but observe that employees of this organization, or of similar organizations represented in the occupation classifier 206, may commonly have three or more titles. Accordingly, the score agent 212 may give titles matched to two different term inputs higher organization score confidence ratings, weightings or score values, to reflect their relative importance over other possible matching titles for this organization that were omitted from entry by the employee. The score agent 212 may also match the person as employee to other titles as a function of this recognition, for example, assigning a third title that is not input by the person with two other (first and second) title text terms as a function of determining that that employees of this organization (or of similar organizations represented in the occupation classifier 206 database) commonly have the third title when they also have the first and second titles.

Outputs of the relevancy module 210 and the score agent 212 are fed back to a post-processor 216 that detects new job title terminology and acronyms and accordingly updates the term dictionary 202 and the classification database of the occupation classifier 206. The post-processor 216 is a learning component that learns correct term substitutions, matches and associations based on frequencies in prior iterations. Aspects dynamically learn new job titles and occupation classifications and trends, updating the term dictionary 202 and occupation classifier databases 206 automatically, or with limited human editing and interaction. Some of the newly recognized titles may only be recognized within certain types of companies, wherein an organization score value may indicate whether or not to match or apply the new titles.

Post-processor 216 aspects may also build templates for specific industries and organizational contexts, for example enabling auto-completion of job title term entries at subsequent input phases, as well as other data, based on recognizing industry sector and organizational context. In some aspects, likely matches may be suggested (at input at 82, or at some other point) in view of the presence of such titles within known organization's structures that are stored in the occupation classifier 206 and relevant to the person as employee as a function of the extracted person or category indicia data, wherein a signal indicating this possible match is generated.

The post-processor 216 may update the term dictionary 202 and the classification database of the occupation classifier 206 by linking input string text terms to their respective identified best-matching titles. Thus, when the same or similar text string terms are subsequently input in future iterations of the process, the linked matching titles may be more quickly or with more (higher) confidence matched to the terms. The text string term inputs may also be associated in a negative fashion with said terms and titles, for example as a result of low confidence scoring associations, to thereby reduce the likelihood of erroneous or low-confidence matching in future iterations.

The term dictionary 202 and occupation classifier 206 databases may be applied based on an industry category or other general context of the organization, and thus in one aspect the identity of the organization itself may be anonymous, provided that the business space or context of the organization is known. Anonymization and de-identification of underlying data of the organizations, person, employees, etc., may be desired, and thereby implemented by aspects of the present invention. For example, data used may be acquired under obligations to anonymize organizations and individuals providing the data. By reducing this information to strong associations with job titles, the connection to the input data of the organizations and individuals may be eliminated. The process does not need to know the names of the companies and people providing the input, but instead only the business space and context from which the data is extracted, and wherein the anonymized data may be used to make useful job title associations. Similarly, organization scores may also be generated by the score agent 212 as a function of looking at titles across the anonymized data of hierarchy of organizations similar or analogous to the organization of the employee: for example, determining that 75% of the employees in the organization profile data are software developers may indicate that software development company hierarchy databases within the occupation classifier 206 should be used to process the string inputs.

The post-processor 216 may update the term dictionary 202 and the classification database of the occupation classifier 206 by adding the text string inputs that are matched to titles as new entries for use in employee classifications. In this fashion, aspects of the present invention provide for dynamic title discovery, and for dynamic and responsive term dictionary and occupation classifier structure creations that can rapidly respond to changes in jargon within the marketplace and accurately match employees to standardized titles useful in employee comparisons within and without employing organizations.

Aspects of the present invention may classify job titles in terms of known and determined organization structures and jobs for use in building a variety of automated human resources analytic products, including wage analysis and prediction, employee flight risk analysis, talent retention, talent acquisition cost analysis and user data quality appraiser tools. Translating original title inputs into different, matched title outputs may also transform the data into more readily-valuated forms. Aspects may match title codes that are valuated and used in salary estimators, stitching in or otherwise bringing in knowledge determined from other organizations and companies with respect to salary range for the identified, matched job title. Such aspects may be useful in correctly estimating salary offers needed to retain employees as a function of organization context, such as industry type, geographic location, etc. Human resource activity around the metrics surrounding many occupations are different from organization to organization, and engines according to the present invention identify the most appropriate or important attributes of the title field inputs for use in data analysis.

Aspects of the present invention include systems, methods and computer program products that implement the aspects described above. A computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

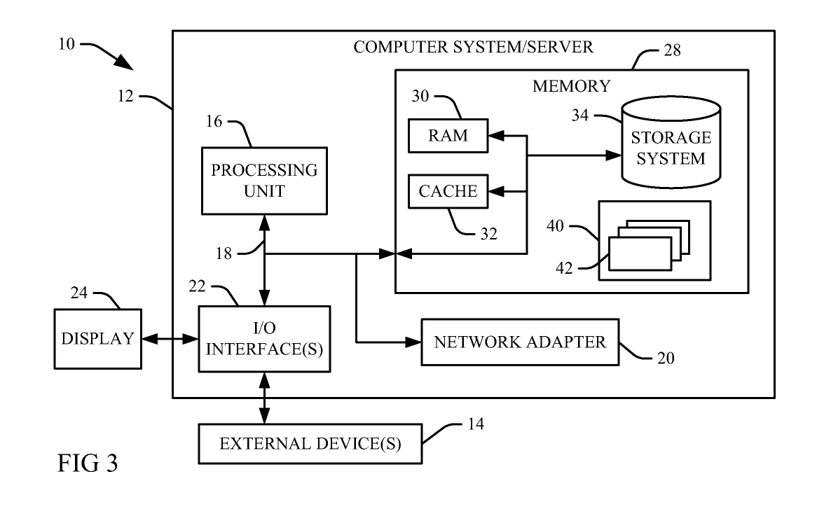

Referring now to FIG. 3, a title engine device 12 is operational with numerous other computing system environments or configurations for score-based title assignment according to the present invention. Examples of well-known computing systems, environments, and/or configurations that may be suitable for use with title engine device 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Title engine device 12 may be described in the general context of computer system-executable instructions, such as program modules, being executed by a computer system. Generally, program modules may include routines, programs, objects, components, logic, data structures, and so on that perform particular tasks or implement particular abstract data types. Title engine device 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, a special purpose, score-based title engine device 12 according to the present invention is a computer system/server device structure located within a cloud computing node 10. The components of the title engine device 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The title engine device 12 typically includes a variety of computer system readable media. Such media may be any available media that is accessible by the title engine device 12, and include both volatile and non-volatile media, removable and non-removable media.

System memory 28 can include computer system readable media in the form of volatile memory, such as random access memory (RAM) 30 and/or cache memory 32. Title engine device 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of a non-limiting example, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the invention as described herein.

Title engine device 12 may also communicate with one or more external devices 14 such as a keyboard, a pointing device, a display 24, etc.; one or more devices that enable a user to interact with title engine device 12; and/or any devices (e.g., network card, modem, etc.) that enable title engine device 12 to communicate with one or more other computing devices. Such communication can occur via Input/Output (I/O) interfaces 22. Still yet, title engine device 12 can communicate with one or more networks, such as a local area network (LAN), a general wide area network (WAN), and/or a public network (e.g., the Internet) via network adapter 20. As depicted, network adapter 20 communicates with the other components of title engine device 12 via bus 18. It should be understood that although not shown, other hardware and/or software components could be used in conjunction with title engine device 12. Examples include, but are not limited to: microcode, device drivers, redundant processing units, external disk drive arrays, RAID systems, tape drives, and data archival storage systems, etc.

In one aspect, a service provider may perform process steps of the invention on a subscription, advertising, and/or fee basis. That is, a service provider could offer to integrate computer-readable program code into the title engine device 12 to enable the title engine device 12 to perform score-based title assignments as discussed in FIGS. 1 and/or 2. The service provider can create, maintain, and support, etc., a computer infrastructure, such as the computer system 12, bus 18, or parts thereof, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 12, from a tangible computer-readable medium device 34; (2) adding one or more computing devices to the computer infrastructure 10; and (3) incorporating and/or modifying one or more existing systems 12 of the computer infrastructure 10 to enable the computer infrastructure 10 to perform process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for score-based title assignment, the method comprising:
in response to a data input of a title text string that indicates a title of a person for a job within an organization, an automated title engine device:
generating title scores in proportion to strength of match to the title text string input for each of a plurality of predefined titles classified within a classification database;
selecting a one of the predefined titles having a highest of the generated title scores as a matching title for the title text string input;
generating a person score for the person from the title score of the matching title as a function of any other title score of any other of the predefined titles that are matched to the person;
generating an organization score as a function of the person score and an occurrence frequency of the matching title associated with the organization; and
updating a classification of the matching title within the classification database as a function of at least one of the organization score, the title score and the person score.

2. The method of claim 1, wherein the data input of the title text string further comprises organizational data that comprises at least one of a department of the person within the organization, a management status of the person, an industry of the organization, and employment hours of the person; and
wherein at least one of the steps of generating the title scores, generating the person score, generating the organization score and updating the classification of the matching title within the classification database are a function of the organizational data.

3. The method of claim 2, wherein the step of generating the organization score is a function of the organizational data and comprises setting a value of the organization score in proportion to a correlation of a position of the person within the organization that is indicated by the organizational data to a position of the matching title within hierarchy data of the classification database.

4. The method of claim 2, wherein the step of generating the person score comprises generating the person score to be proportionate to a total number of the predefined titles that have title scores.

5. The method of claim 2, wherein the step of generating the person score is a function of the organizational data and comprises setting the person score as a function of the title score, the management status of the person, an industry of the organization and employment hours of the person of the organizational data.

6. The method of claim 2, further comprising:
extracting feature signals of the title text string and the organizational data by at least one of string level extraction, machine translation, pattern identification, stop-word, relation identification, tokenization, punctuation, lemmatizer and stemmer processes; and
generating at least one of the title score, the person score and the organization score as a function of the extracted feature signals.

7. The method of claim 6, further comprising:
transforming the input text string into a root job function component with a modifying subject matter scope dependency;
generating at least one profile score by processing the root job function component and modifying subject matter scope dependency as a function of an industry profile model, an organization profile model and a department profile model; and
generating at least one of the title score, the person score and the organization score as a function of the at least one profile score.

8. The method of claim 7, wherein the step of updating the classification of the matching title within the classification database comprises linking the matching title to the title text string input with a confidence value determined as a function of the title score and at least one of the person score and the organization score.

9. The method of claim 2, wherein the automated title engine device is a computer system comprising a processor, a computer readable memory in circuit communication with the processor, and a computer readable storage medium in circuit communication with the processor, the method further comprising:
integrating computer-readable program code into the computer system; and
wherein the computer system processor executes program code instructions stored on the computer-readable storage medium via the computer readable memory and thereby performs the steps of generating the title scores, selecting the one of the predefined titles having the highest of the generated title scores as the matching title for the title text string input, generating the person score, generating the organization score, and updating the classification of the matching title within the classification database as the function of at least one of the organization score, the title score and the person score.

10. A system, comprising:
a processor;
a computer-readable memory in circuit communication with the processor; and
a computer-readable storage medium in circuit communication with the processor;
wherein the processor executes program instructions stored on the computer-readable storage medium via the computer-readable memory and thereby:
in response to a data input of a title text string that indicates a title of a person for a job within an organization, generates title scores in proportion to strength of match to the title text string input for each of a plurality of predefined titles classified within a classification database;
selects a one of the predefined titles having a highest of the generated title scores as a matching title for the title text string input;
generates a person score for the person from the title score of the matching title as a function of any other title score of any other of the predefined titles that are matched to the person;
generates an organization score as a function of the person score and an occurrence frequency of the matching title associated with the organization; and
updates a classification of the matching title within the classification database as a function of at least one of the organization score, the title score and the person score.

11. The system of claim 10, wherein the data input of the title text string further comprises organizational data that comprises at least one of a department of the person within the organization, a management status of the person, an industry of the organization, and employment hours of the person; and
wherein the processor executes the program instructions stored on the computer-readable storage medium via the computer-readable memory to thereby further generate at least one of the title scores, the person score and the organization score as a function of the organizational data, or update the classification of the matching title within the classification database as a function of the organizational data.

12. The system of claim 11, wherein the processor executes the program instructions stored on the computer-readable storage medium via the computer-readable memory to thereby further:
generate the organization score as a function of the organizational data; and
set a value of the organization score in proportion to a correlation of a position of the person within the organization that is indicated by the organizational data to a position of the matching title within hierarchy data of the classification database.

13. The system of claim 11, wherein the processor executes the program instructions stored on the computer-readable storage medium via the computer-readable memory to thereby further generate the person score to be proportionate to a total number of the predefined titles that have title scores.

14. The system of claim 13, wherein the processor executes the program instructions stored on the computer-readable storage medium via the computer-readable memory to thereby further:
generate the person score as a function of the organizational data; and
set the person score as a function of the title score, the management status of the person, an industry of the organization and employment hours of the person of the organizational data.

15. A computer program product for score-based title assignment, the computer program product comprising:
a computer-readable storage medium having computer-readable program code embodied therewith, the computer-readable program code comprising instructions for execution by a processor that cause the processor to:
in response to a data input of a title text string that indicates a title of a person for a job within an organization, generate title scores in proportion to strength of match to the title text string input for each of a plurality of predefined titles classified within a classification database;
select a one of the predefined titles having a highest of the generated title scores as a matching title for the title text string input;
generate a person score for the person from the title score of the matching title as a function of any other title score of any other of the predefined titles that are matched to the person;
generate an organization score as a function of the person score and an occurrence frequency of the matching title associated with the organization; and
update a classification of the matching title within the classification database as a function of at least one of the organization score, the title score and the person score.

16. The computer program product of claim 15, wherein the data input of the title text string further comprises organizational data that comprises at least one of a department of the person within the organization, a management status of the person, an industry of the organization, and employment hours of the person; and
wherein the computer-readable program code instructions for execution by the processor further cause the processor to generate at least one of the title scores, the person score and the organization score as a function of the organizational data, or update the classification of the matching title within the classification database as a function of the organizational data.

17. The computer program product of claim 16, wherein the computer-readable program code instructions for execution by the processor further cause the processor to:
generate the person score as a function of the organizational data; and
set the person score as a function of the title score, the management status of the person, an industry of the organization and employment hours of the person of the organizational data.

18. The computer program product of claim 17, wherein the computer-readable program code instructions for execution by the processor further cause the processor to:
extract feature signals of the title text string and the organizational data by at least one of string level extraction, machine translation, pattern identification, stop-word, relation identification, tokenization, punctuation, lemmatizer and stemmer processes; and
generate at least one of the title score, the person score and the organization score as a function of the extracted feature signals.

19. The computer program product of claim 18, wherein the computer-readable program code instructions for execution by the processor further cause the processor to:
transform the input text string into a root job function component with a modifying subject matter scope dependency;
generate at least one profile score by processing the root job function component and modifying subject matter scope dependency as a function of an industry profile model, an organization profile model and a department profile model; and
generate at least one of the title score, the person score and the organization score as a function of the at least one profile score.

20. The computer program product of claim 19, wherein the computer-readable program code instructions for execution by the processor further cause the processor to update the classification of the matching title within the classification database by linking the matching title to the title text string input with a confidence value determined as a function of the title score and at least one of the person score and the organization score.
